(19) United States
(12) Patent Application Publication
(10) Pub. No.: US 2009/0068502 A1
(43) Pub. Date: Mar. 12, 2009

(54) Remote emergency power unit having electrochemically regenerated carbon dioxide scrubber

(76) Inventors: Dennis A. Corrigan, Troy, MI (US); Peter J. Kalal, Painted Post, NY (US); Robin A. Vidas, Fenton, MI (US); Srinivasan Venkatesan, Southfield, MI (US)

Correspondence Address: ENERGY CONVERSION DEVICES, INC., 2956 WATERVIEW DRIVE, ROCHESTER HILLS, MI, 48309, US

(21) Appl. No.: 12/154,253

(22) Filed: May 21, 2008

Related U.S. Application Data
(60) Provisional application No. 60/931,027, filed on May 21, 2007.

(51) Int. Cl. H01M 8/04

(52) U.S. Cl. 429/12

(57) ABSTRACT

An emergency power system is provided in accordance with an exemplary embodiment of the present invention. The emergency power system includes a fuel cell and an electrochemically regenerated air scrubber which removes carbon dioxide from air.

### FIELD OF THE INVENTION

The present invention generally relates to fuel cell power systems and particularly to regenerative methods and apparatus for removal of carbon dioxide from air streams used in remote emergency alkaline fuel cell power systems.

### BACKGROUND

A fuel cell is an energy conversion device that directly converts the energy of a supplied fuel into electric energy. Researchers have been actively studying fuel cells to utilize the fuel cell's potential high energy generation efficiency. The base unit of the fuel cell is a cell having an oxygen electrode, a hydrogen electrode, and an appropriate electrolyte. Fuel cells have many potential applications such as supplying power for transportation vehicles, replacing steam turbines and power supply applications of all sorts. Despite their seeming simplicity, many problems have prevented the widespread usage of fuel cells.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources based upon the Carnot cycle.

The major components of a typical fuel cell are the hydrogen electrode for hydrogen oxidation and the oxygen electrode for oxygen reduction, both being positioned in a cell containing a fuel cell electrolyte (such as an alkaline electrolytic solution). Typically, the reactants, such as hydrogen and oxygen, are respectively fed through a porous hydrogen electrode and oxygen electrode and brought into surface contact with the fuel cell electrolyte. The particular materials utilized for the hydrogen electrode and oxygen electrode are important since they must act as efficient catalysts for the reactions taking place.

In a hydrogen-oxygen alkaline fuel cell, the reaction at the hydrogen electrode occurs between hydrogen fuel and hydroxyl ions (OH⁻) present in the fuel cell electrolyte, which react to form water and release electrons:

H₂+2OH⁻→2H₂O+2e⁻.

At the oxygen electrode, oxygen, water, and electrons react in the presence of the oxygen electrode catalyst to reduce the oxygen and form hydroxyl ions (OH⁻):

O₂+2H₂O+4e⁻→4OH⁻.

The flow of electrons is utilized to provide electrical energy for a load externally connected to the hydrogen and oxygen electrodes.

In alkaline fuel cells, carbonate poisoning of the fuel cell electrolyte is a known problem. Carbonate is formed when carbon dioxide, present in the air supply, contacts the alkaline fuel cell electrolyte and reacts to form carbonate ions. The presence of carbonate ions in solution decreased performance of the fuel cell by reducing the conductivity of the electrolyte solution, increasing the viscosity of the electrolyte, and decreasing oxygen reduction kinetics in the fuel cell. Furthermore, carbonates may precipitate out of solution and clog the pores of the hydrogen and oxygen electrodes further reducing performance of the fuel cell by reducing access of the electrolyte to catalytically active sites. While the formation of carbonates may be prevented or minimized by supplying a pure oxygen stream to the fuel cell, it is much more cost effective to utilize air from the atmosphere as the fuel cell oxygen supply.

Air from the atmosphere which is supplied to fuel cells contains approximately 370 parts per million carbon dioxide. When the carbon dioxide contained in the air contacts a fuel cell electrolyte, such as potassium hydroxide, the following reaction occurs:

CO₂+2KOH [symbol] K₂CO₃+H₂O

To prevent the formation of carbonate in fuel cells utilizing an air stream as a source of oxygen, different methods have been used to remove carbon dioxide from the air stream. Such methods may include passing the air supply through a bed of soda lime, utilization of amine based systems, utilization of molecular sieves formed from carbon fiber composites, utilization of carbon dioxide adsorbing ceramics, utilization of sodium peroxide, water gas shift membrane reactors, pressure swing adsorption, and use of liquid hydrogen to condense carbon dioxide out of the air. All of these solutions, however, may be costly and/or require constant monitoring and changing of the beds through which the air is supplied. For instance, any type beds utilizing a carbon dioxide adsorbing material must be replaced after a carbon dioxide adsorption limit is reached whereby the beds cannot adsorb any additional carbon dioxide. Furthermore, these types of systems also add significant weight and volume to the systems in which they are used.

Alternatively or in addition to carbon dioxide removal from the air supply, methods for removal of carbonate from the fuel cell electrolyte have also been used. Such methods include in situ electrochemical removal of carbonates from the electrolyte via high current density and acidification (sulfate cycle) and ex situ electrochemical removal of carbonates from the electrolyte via electrolysis. Although these methods of carbonate removal may be beneficial for certain applications, they are not without problems. Removal of carbonates from the fuel cell electrolyte of fuel cell cells via high current density can destroy the electrodes within the electrochemical cell as the electrodes may not be able to sustain the high current density. Furthermore, electrolyte removal via high current density may require the use of additional cells. The removal of carbonates from a fuel cell electrolyte via acidification requires a high overvoltage to electrolyze the solution, reduces the reactivity of the hydroxide, and is very inefficient due to the neutralization of highly concentrated hydroxide by acid through repeated cycling. The ex situ electrolyte removal of carbonate via electrolysis consumes a great deal of energy and is not very efficient due to the inability to create a low hydroxyl ion concentration in the fuel cell electrolyte.

A process similar which utilizes the ex situ electrolyte removal of carbonate is disclosed by Gilligan, III et al. in U.S. Pat. No. 4,337,126. Gilligan, III et al. disclose an electrolytic process for converting alkali metal carbonates to alkali metal hydroxides at high current efficiencies. The electrolytic process utilizes a electrolytic anode contained in an anodic compartment and an electrolytic cathode contained in a cathodic compartment. The anodic and cathodic compartments both contain an electrolyte with the compartments being separated by a cation permselective membrane which allows the passage of metal cations therethrough. An alkaline metal carbonate solution is continually fed into the anodic chamber and decomposed to form hydrogen, carbon dioxide, and metal cations. Cations formed at the electrolytic anode pass through the cation permselective membrane to the cathodic compartment and reacted with hydroxide ions produced at the electrolytic cathode to form alkali metal hydroxide.

While various systems and methods exist for removing carbon dioxide from the air stream which enters the fuel cell, thereby preventing carbonate from forming in the alkaline electrolyte thereof, none of these systems and methods allow for economical and automatic regeneration of the carbon dioxide scrubbing capability in situ, and most require periodic exchange of the active ingredient of the scrubbing system.

Further, while some systems and methods have been proposed and used to remove carbonate from alkaline fuel cell electrolyte in situ or ex situ, the damage of the carbonate has already begun by the time the carbonate forms. That is, the carbonate is formed in the pores of the electrodes of the fuel cell and localized precipitation with the pores is likely to occur long before any removal process begins on the electrolyte. Further complicating the carbonate removal from the fuel cell electrolyte is the fact that electrochemical reduction of the carbonate to reconvert it to carbon dioxide requires a very acidic environment. Thus to remove the carbonate, the active ingredient of the fuel cell electrolyte, i.e. the hydroxyl ions (OH⁻), must be destroyed to make the solution acidic. This consumes additional electrochemical energy, and in turn destroys at least a portion of the electrolyte. While, the amount of extra energy used and the loss of electrolyte can be minimized by using certain localization techniques during the electrochemical removal of the carbonate, the method is still an “after the fact” mitigation, which need not be employed if carbon dioxide is removed from the air prior to introduction to the fuel cell.

The devices described in Gilligan, supra, and Sloan (U.S. Pat. No. 4,049,519) appear to use cation-selective membranes, such as Nafion. Ion-selective membranes tend to be expensive. There is also mention of Pt group metal-based catalysts, which are also expensive. The Katz patent (U.S. Pat. No. 3,990,912) also mentions a Pd—Ag diffusion membrane. The Katz patent further mentions the use of an asbestos-type mat for a diffusion barrier. Although it is possible that there are alternatives to asbestos, it can be difficult to find suitable replacements.

Prior art methods using higher current densities can introduce some systems and cost complications. For example fuel cell current densities as high as 400 mA/cm² for a period of 100 hours are used to remove the carbonate from the electrolyte of an alkaline fuel cell (having a typical usage current density of 100 Ma/cm²). Depending on the fuel cell stack performance capabilities, this wide range of current densities required can result in a need to oversize the fuel cell stack. This makes the overall system more expensive since the balance of plant will also need to be oversized. Also, having this type of wide operation range can make the power electronics more complicated and expensive since the power conditioning devices will need to handle a much wider range of voltages and currents.

Generally, there is a need to have a CO₂ or carbonate removal device that is compact, lightweight, low-maintenance, and inexpensive. The device should also consume a minimal amount of power for operation and have high efficiencies. Thus, there is a need in the art for an inexpensive, automatically regenerative, carbon dioxide scrubber and method for use in removal of carbon dioxide from the air stream provided to fuel cell power generation systems.

### SUMMARY OF THE INVENTION

An emergency power system is provided in accordance with an exemplary embodiment of the present invention. The emergency power system includes a fuel cell and an electrochemically regenerated air scrubber which removes carbon dioxide from air.

### BRIEF DESCRIPTION OF THE DRAWINGS

FIG. 1 is a block diagram of an emergency back-up power system, including a fuel cell and a regenerative air scrubber according to the present invention;

FIG. 2 is a simplified schematic depiction of an electrolytic cell which forms a part of the regenerative air scrubber for use in the emergency back-up power system according to the present invention;

FIG. 3 is a schematic depiction of one embodiment of a regenerative air scrubber for use in the emergency back-up power system according to the present invention, specifically shown are the air scrubbing reactor and the regenerative electrolytic cell;

FIG. 4 is a schematic depiction of another embodiment of a regenerative air scrubber for use in the emergency back-up power system according to the present invention; and

FIG. 5 depicts yet another embodiment of a regenerative air scrubber for use in the emergency back-up power system according to the present invention, specifically shown is a packed bed air scrubbing reactor;

FIG. 6 is a schematic representation of a beaker-scale test setup for electrochemical carbon dioxide ejection from a carbonate solution;

FIG. 7 is a block diagram of an Electrochemical Electrolyte Regeneration (EER) device useful in the present invention;

FIG. 8 is a block diagram of an Electrochemically Regenerative Scrubber (ERS) device useful in the present invention;

FIG. 9 is a schematic diagram of MHFC fuel cell system design with a prior art soda lime scrubber;

FIG. 10 is a schematic diagram of MHFC fuel cell system design with an Electrochemical Electrolyte Regeneration (EER) device in place of the soda lime scrubber; and

FIG. 11 is a schematic diagram of MHFC fuel cell system design with Electrochemically Regenerative Scrubber (ERS) device in place of the soda lime scrubber.

### DETAILED DESCRIPTION OF THE PREFERRED EMBODIMENTS OF THE INVENTION

In its most basic form, the present invention is a self-contained, electrochemically regenerative, air scrubber for removing carbon dioxide from air. The scrubber is very useful in combination with fuel cell systems which use air as the oxidant therefore, and is particularly useful in combination with alkaline fuel cell systems. The combination of the air scrubber and fuel cell system is particularly useful for emergency backup power applications, especially those used in remote locations.

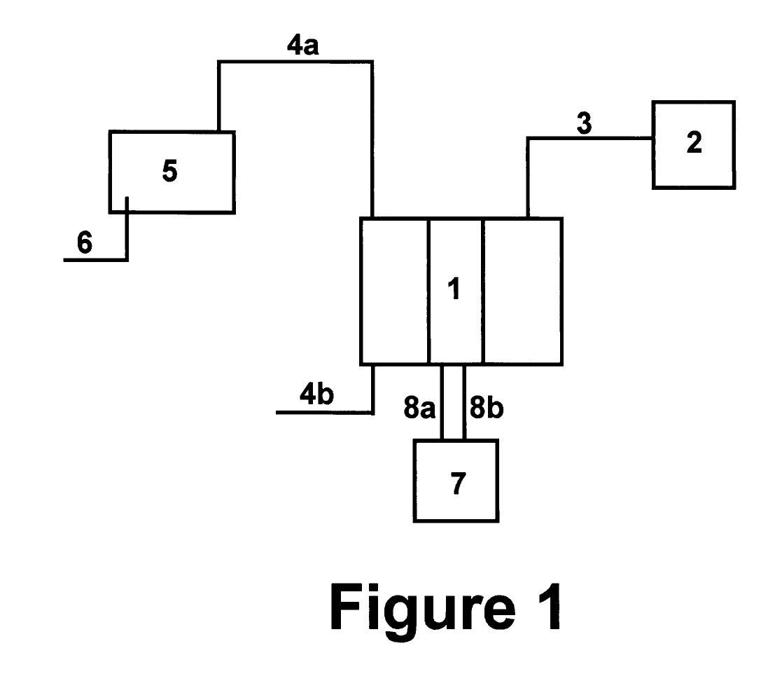

FIG. 1 depicts a fuel cell emergency power system as contemplated by the instant invention. The system includes a fuel cell 1, connected to a source of fuel 2 by a fuel supply line 3. Typically the fuel is hydrogen and the source includes a hydrogen storage means of some sort. Particularly safe and useful is storage of hydrogen in metal hydride storage tanks. Such tanks or small canisters are becoming commercially available and as such are readily available and interchangeable as needed. The oxidant for the fuel cell 1 is the oxygen in the air which is delivered to the fuel cell via supply line 4a. Spent air, from which oxygen has been extracted, is released from the fuel cell via line 4b. Fuel cell electrolyte may be static or may be circulated through the system via lines 8a and 8b with excess fuel cell electrolyte stored in a reservoir 7. Reservoir 7 may also act as a fuel cell electrolyte treatment and conditioning apparatus.

Up to this point, the system is typical of any fuel cell system, particularly a fuel cell system using a liquid fuel cell electrolyte. However, when the fuel cell uses an aqueous alkaline fuel cell electrolyte there can be a problem using air as the oxygen containing oxidant. The problem arises from the carbon dioxide in the air. The carbon dioxide forms carbonates when exposed to the alkaline fuel cell electrolyte. As described earlier, these carbonates are highly undesirable in the fuel cell and can eventually cause degradation and failure of the fuel cell. To remedy this problem, carbon dioxide scrubbers are typically used to clean the air stream before it enters the fuel cell. A carbon dioxide scrubber 5 is shown in FIG. 1. Ambient air enters the device via line 6 and treated air, from which carbon dioxide has been removed, exits through line 4a, which leads to the air input of the fuel cell 1.

Unfortunately, most carbon dioxide scrubbers on the market involve irreversible chemical reactions that use a chemical scrubbing agent. This type of scrubber must be replaced periodically when the chemical scrubbing agent becomes all used up. Other systems have reversible chemistries, but require exotic and possibly dangerous materials and/or extremes of temperature/pressure to be regenerated. These constraints make such a scrubbing system either unpractical, unsafe or uneconomical to use.

The inventors have come up with a self-contained, electrochemically regenerative, air scrubber for removing carbon dioxide from air. The scrubber is simple, economical, relatively safe (doesn't use exotic or inherently hazardous chemicals) and best of all, automatically electrochemically regenerative, which means that no one needs to visit the site for periodic replacement or maintenance of the scrubber.

In its most basic form the scrubber 5 comprises a reaction chamber filled with a hydroxide solution, such as an aqueous solution of potassium hydroxide. The scrubber also includes a fresh air inlet 6 and a scrubbed air outlet 4a. Air containing CO₂ is contacted with the hydroxide solution and the CO₂ reacts with the potassium hydroxide via the following reaction.

CO₂+2KOH [symbol] K₂CO₃+H₂O

Generically for any aqueous hydroxide solution the reaction may be shown as:

CO₂+2OH⁻ [symbol] CO₃⁻²+H₂O

thus, two hydroxyl ions are destroyed by one molecule of carbon dioxide, generating one carbonate ion and one water molecule. In this way, the carbon dioxide is removed from the air (i.e. the air is scrubbed of CO₂).

This is a very effective and simple way of removing the CO₂ from the air stream and the air leaving the scrubber via outlet line 4a is relatively free from CO₂. Unfortunately, this setup alone would not be regenerative or maintenance free. Eventually all of the hydroxyl ions would be used up and the solution would become a carbonate solution. Also, depending on the solubility limit of the particular carbonate formed, the metal carbonate may precipitate from solution. Thus eventually, the system would need maintenance, even if only to replenish the hydroxide solution. It should also be noted that even if the scrubber system had a large supply of fresh solution, it would eventually be depleted and maintenance would be required. Therefore, the present inventors have included an electrochemical method for removing the carbonate ions from the solution, thereby replenishing the hydroxide ions and refreshing the scrubbing capability thereof.

For emergency back-up power applications, the amount of the hydroxide solution within the scrubber of the instant invention needs to minimally be at least enough to scrub the air when the fuel cell is being used during a power outage. Thus, if the normal anticipated outage statistically always lasts less than a certain amount of time (e.g. 12 hours), then the hydroxide solution within the scrubber should minimally be adequate to scrub all of the air needed to run the fuel cell at full power for the full duration of the power outage (i.e. for 12 hours). During the power outage, no power is taken from the fuel cell to replenish the hydroxide scrubbing solution.

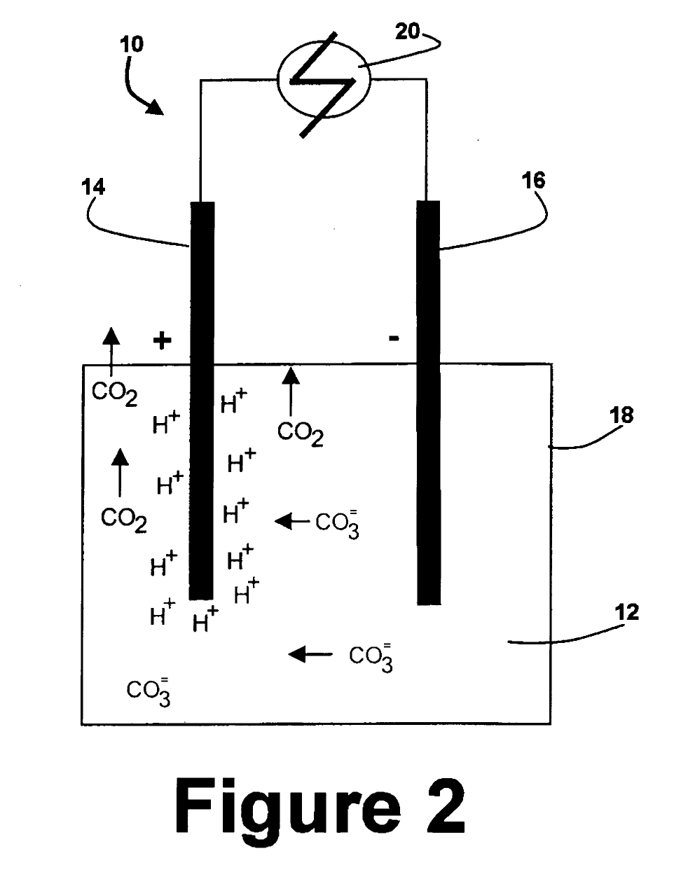

Once power to the electrical grid has been restored, then the hydroxide solution can be electrochemically replenished using power from the grid. To accomplish this, the scrubber includes an electrolytic cell that locally converts the carbonate ions to carbonic acid, which decomposes and releases CO₂ from the solution while replenishing hydroxyl ions in the solution. A very generalized depiction of such an electrolytic cell 10 is shown in FIG. 2. The cell includes anode 14 and cathode 16 which are powered by the energy grid 20. It should be noted that while the electric grid is the simplest power source 20 to regenerate the scrubbing solution 12, other sources of power may be used such as solar cells, wind generators, etc. The cell further includes a housing 18 which holds the carbonated scrubbing solution 12. This scrubbing solution 12 is also the electrolyte of the electrolytic cell 10 and the terms “scrubbing solution” and “electrolyte” may be used interchangeably herein after.

This is a basic system for removing carbonates from the alkaline solution via electrolysis. During operation of the carbonate removal system, oxygen is produced at the electrolytic anode via electrolysis by the following reaction:

4OH⁻ [symbol] O₂+4e⁻+2H₂O

As the hydroxyl ion concentration near the anode begins to significantly decrease due to the consumption thereof by the above reaction, the local environment becomes increasingly acidic. This in turn enables the decomposition of the carbonate ions which ultimately yields carbon dioxide and water via the following reactions:

CO₃⁻²+H₂O→HCO₃⁻+OH⁻ (Hydrolysis of carbonate to bicarbonate)

HCO₃⁻+H₂O→H₂CO₃+OH⁻ (Hydrolysis of bicarbonate to carbonic acid)

H₂CO₃→H₂O+CO₂↑ (Decomposition of carbonic acid and release of CO₂)

Once the concentration gradient is established between the local anode environment and the electrolyte bulk, the rate of decomposition of carbonate to water and carbon dioxide (and release of gaseous CO₂) is determined by the transport of carbonate ions into the low hydroxyl ion concentration region. The concentration gradient is further aided by the preferential migration of the divalent carbonate ions towards the electrolytic anode.

As oxygen is produced and carbonate ions are decomposed at the electrolytic anode, hydrogen and hydroxyl ions are produced at the electrolytic cathode via electrolysis by the following reaction:

2H₂O+2e⁻ [symbol] H₂+2OH⁻

The hydroxyl ions generated at the electrolytic cathode 16 replenishes the hydroxyl ions consumed at the electrolytic anode 14 thereby maintaining the concentration of hydroxyl ions in the electrolyte 12. The hydrogen generated by the reaction at the electrolytic cathode 16 may be vented to the atmosphere but is preferentially recycled and utilized to replenish the fuel consumed during operation of the fuel cell system during the power outage. This will be more fully discussed herein below.

While the environment around the anode 14 will become locally acidic, this effect can be enhanced using some sort of means for at least partially isolating the electrolyte region around the anode. Generically this partition is known as an anode isolation chamber. The isolated electrolyte (anolyte) remains in fluid communication with the electrolyte bulk which allows circulation of the electrolyte through the anode isolation chamber (anolyte chamber) via concentration gradients. The anode isolation chamber may comprise any structure which temporarily isolates at least a portion of the electrolyte adjacent the electrolytic anode from the bulk of the electrolyte such that the isolated electrolyte and the bulk electrolyte remain in fluid communication. To prevent the carbon dioxide produced via the electrolytic reactions from contacting the electrolyte and producing carbonate, the upper end of the anode isolation chamber may be closed with an exhaust conduit extending from the anode isolation chamber to the atmosphere through which carbon dioxide and oxygen are vented from the system.

The anode isolation chamber may be comprised of any type material compatible with the alkaline environment which at least partially isolates the electrolyte adjacent to the anode from the bulk of the electrolyte. Preferably, the isolation chamber may be comprised of a separator, a semi-permeable membrane, an ion-exchange membrane, or combinations thereof.

As oxygen is produced and carbonate is decomposed at the electrolytic anode, the oxygen and carbon dioxide produced at the electrolytic anode are preferably vented into the atmosphere. The carbon dioxide concentration in the carbon dioxide/oxygen mixture, which is substantially greater than the 370 ppm present in air, makes the carbon dioxide/oxygen mixture not particularly suitable for fuel cell applications as the carbon dioxide will once again form carbonate ions when exposed to the fuel cell electrolyte. The carbon dioxide/oxygen mixture may be vented to the atmosphere via one or more exhaust conduits in gaseous communication with the anode isolation chamber.

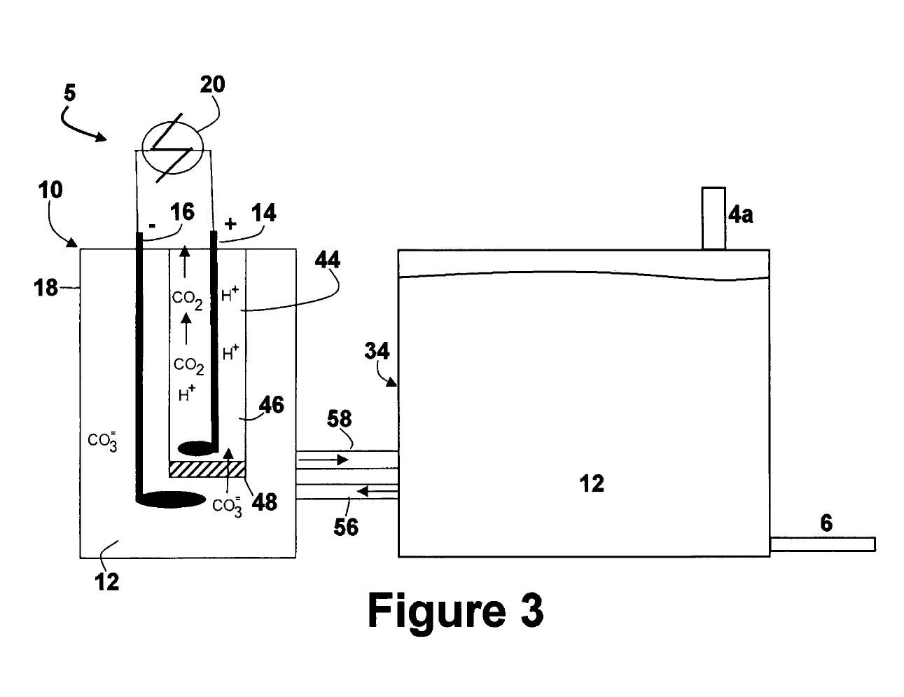

In one embodiment of the present invention as depicted in FIG. 3, the anode isolation chamber 44 may be a tubular structure having an open top, open bottom and a side wall. While the tubular structure may have a circular cross section, conceivably, the tubular structure may also have a triangular, square, rectangular, or polygonal cross section. The anode isolation chamber allows the electrolyte adjacent to the electrolytic anode (the anolyte) 46 to remain in fluid communication with the electrolyte bulk. The length and diameter of the tube structure may vary. The anolyte chamber 44 may be isolated from the rest of the electrolyte 12 by a membrane 48 such as a semipermiable membrane, etc. as suggested herein above. The electrolytic cell 10 is in fluid communication with the scrubbing chamber 34 via lines 56 and 58. During a power outage, air is pumped into the scrubbing chamber 34 via air inlet 6, and scrubbed air exits the scrubber chamber 34 via air outlet line 4a. The scrubber preferably includes at least enough scrubbing solution 12 (also known as the electrolyte 12 of the electrolytic cell 10) to scrub all of the air needed to run the emergency power for system for a designated period of time. Once the power outage is over, air ceases flowing into the scrubber, and the scrubbing solution is cycled from the scrubbing chamber 34 into the electrolytic cell 10. The electrolytic cell 10 is energized via grid power 20 and the scrubbed carbon dioxide is removed from the scrubbing solution 12 as described herein above, thereby regenerating the scrubbing solution 12.

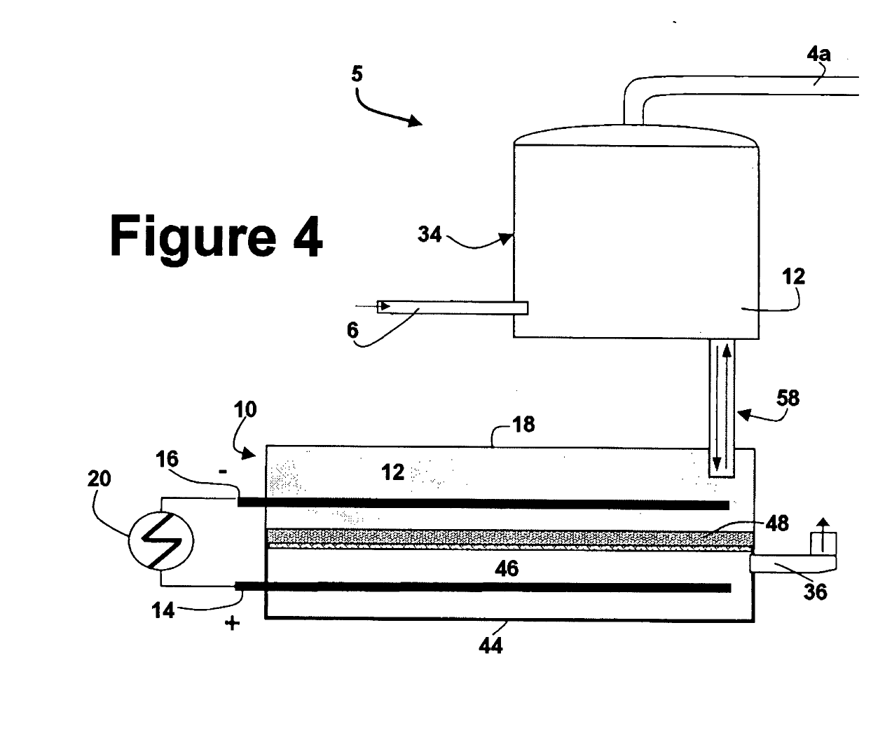

Another embodiment of the present invention is shown in FIG. 4. The apparatus of this embodiment acts in the same way as that of FIG. 3. One difference is that there is only one conduit 58 to transfer scrubbing solution between the scrubbing chamber 34 and the electrolytic cell 10. Also, the oxygen and carbon dioxide produced at the electrolytic anode 14 exits the anode isolation chamber 44 and is vented to the atmosphere via an exhaust conduit 36 providing gaseous communication between the anode isolation chamber 44 and the atmosphere. The exhaust conduit allows the carbon dioxide and oxygen produced at the electrolytic anode 14 to exit the system without contacting the electrolyte in the scrubbing chamber 34. In this embodiment, the anode isolation chamber 44 may be formed by inserting a membrane or separator 48 between the electrolytic anode and the bulk of the electrolyte while allowing fluid communication between the isolated electrolyte 46 and the bulk electrolyte 12. In such case, the anode isolation chamber is formed by the membrane or separator and a portion of the walls 18 of the electrolytic cell 10.

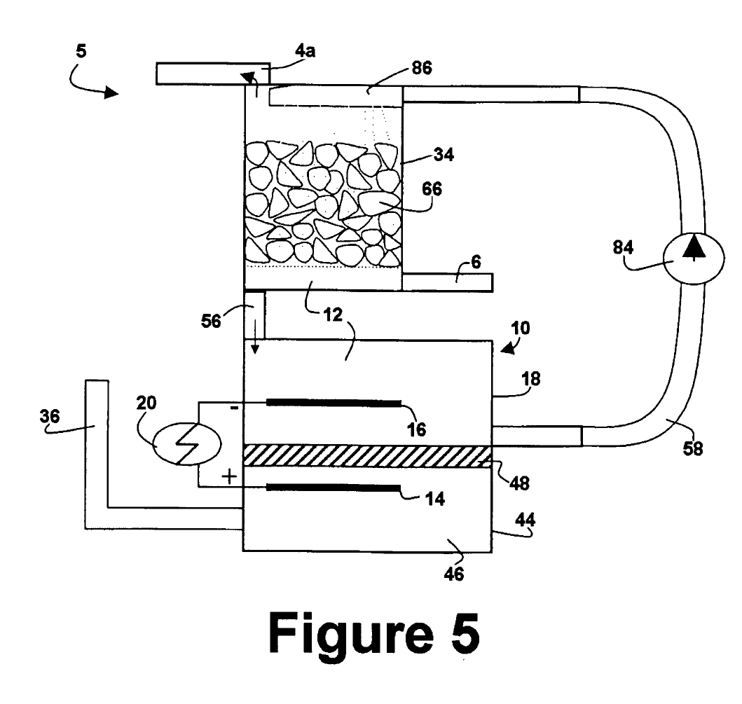

In yet another embodiment, shown in FIG. 5, a packed bed reactor is used in the reaction chamber 34 for scrubbing the carbon dioxide from the air during the power outage. Ambient air is passed into the reactor 34 via inlet 6. The air is passed upward through the packing 66 of the reactor, which is wetted or immersed in scrubber solution 12. The scrubber solution is circulated by pump 84 from the bottom of the reactor chamber 34 to the electrolytic cell 10 via conduit 56 and back to the top of the reactor chamber 34 through conduit 58. Once the scrubber solution is back at the top, it is spread over the packed bed via distributor 86, which may also atomize the scrubber fluid 12.

The carbon dioxide scrubber of the emergency power system may further include a control system which measures the length of time of the power outage or the amount of carbonate in the electrolyte 12. In turn the control system will turn the carbonate removal system on and off based these measurements. For example, control system may include a conductivity meter which calculates the amount of carbonate present in the electrolyte 12 based on the conductivity thereof.

It should be noted that during carbonate removal, hydrogen gas is generated at the cathode 16. This hydrogen can be stored as desired and later used to run the fuel cell 1 during the next power outage. In fact, the electrolytic cell 10 can continue to run beyond the period of time necessary to remove the carbonate from the electrolyte, producing additional hydrogen. In this way, all of the hydrogen used during short to moderate duration power outages may be regenerated via the electrolytic cell 10, using power from the grid 20. Therefor, the control system of the scrubber may also calculate or measure the amount of hydrogen used in the power outage and run the electrolytic cell 10 long enough to regenerate the used hydrogen, which is more than long enough to also remove the carbonate from the scrubbing solution 12. It should be noted that to efficiently use the hydrogen generated by the electrolytic cell, at least a portion of the hydrogen stored in the source of fuel 2 (FIG. 1) must be stored at low pressure. One of the easiest ways to accomplish this is the used of canisters of low plateau pressure metal hydride storage materials.

The electrolytic anode generally comprises an electrolytic anode active material supported by a substrate. The electrolytic anode active material may be any material generally used for electrolytic anodes as known to those skilled in the art. The electrolytic anode material may formed from a host matrix including at least one transition metal element, preferably Co, Ni, or Mn, which is structurally modified by incorporating one or more modifier elements, one of which may be a transition metal element, to improve its catalytic properties. Modifier elements such as Co, Ni, Cr, Li, In, K, Sn, C, O, Mn, Ru, and Al structurally modify the local chemical environments of the host matrix to provide a material having an increased density of catalytically active sites. The material may also include one or more leachable elements, such as Li, Al, or Zn, which are subsequently at least partially leached out to leave a layer of a higher surface to volume ratio, which increases catalytic activity by further modifying the catalytic material. These types of electrolytic anodes are described in detail in U.S. Pat. No. 4,537,674 to Ovshinsky et al., the disclosure of which is hereby incorporated by reference.

The substrate used for the electrolytic anode may be any of the conventional substrates used for electrolytic anodes. Conventional substrates include sheet, expanded metal, wire or screen configurations. The substrates may be formed from nickel, steel, titanium, graphite, copper, or other suitable materials.

The electrolytic cathode generally comprises an electrolytic cathode active material supported by a substrate. The electrolytic cathode active material may be any material generally used for electrolytic cathodes as known to those skilled in the art. The electrolytic cathode active material may be comprised of a host matrix including at least one transition element which is structurally modified by incorporating one or more modifier elements, at least one of which is a transition metal element to improve the catalytic properties of the electrode. Modifier elements, including for example Ti, Mo, Sr, Si, La, Ce, O, and Co, structurally modify the local chemical environment of the host matrix formed of a transition element such as Ni, Mo, or Co to provide a material having an increased density of catalytically active sites which exhibits low overvoltages. These types of electrolytic cathodes are described in detail in U.S. Pat. No. 4,545,883 to Ovshinsky et al., the disclosure of which is hereby incorporated by reference.

The substrate used for the electrolytic cathode may be any of the conventional substrates used for electrolytic cathodes. Conventional substrates include sheet, expanded metal, wire or screen configurations. The substrates may be formed from nickel, steel, titanium, graphite, copper, or other suitable materials.

The carbon dioxide issue has been an overwhelming barrier to the use of AFC technology for terrestrial applications for about 50 years. This is not an easy problem. Many types of scrubber devices have been developed particularly in earlier years prior to 1980 when AFC development was much more active. The lack of a practical way to handle the issue of carbon dioxide absorption into alkaline electrolyte is widely touted as the key barrier for the commercialization of AFC technology for terrestrial applications.

### Electrolysis Regeneration Concept

As a solution to the carbon dioxide issue for AFC technology, we propose the use of an electrolysis device that can eject carbon dioxide from a carbonated electrolyte. Electrolysis produces hydrogen ions (or equivalently consumes hydroxide ions) at the anode:

2H₂O→O₂+4H⁺+4e⁻ <Reaction 1>

resulting in the stepwise formation of carbonic acid:

H⁺+CO₃⁻⁻→HCO₃⁻ <Reaction 2>

H⁺+HCO₃⁻→H₂CO₃ <Reaction 3>

Which hydrolyzes at about pH 7, ejecting carbon dioxide from solution:

H₂CO₃→H₂O+CO₂ <Reaction 4>

The electrochemical ejection of carbon dioxide from carbonated solutions proceeds as a combination of Reactions 1-4 with the overall reaction being:

2CO₃⁻⁻→O₂+2CO₂+4e⁻ <Reaction 5>

Assuming 100% coulombic efficiency for Reaction 5, CO₂ can be ejected at a rate of 0.4 g/Ah of electrolysis (assuming a practically attainable electrolysis voltage of 2 V). Thus, in principle, CO₂ ejection via electrolysis could be performed using fuel cell power with a parasitic loss of <1% of the energy generated by the fuel cell. (Assuming typical operational conditions of 3 times stoichiometric air input and an operational voltage of 0.7V per cell, complete absorption of the 370 ppm CO₂ in air would result in about 3 mg of CO₂ electrolyte absorption per Wh of operation. Removal of CO₂ at the same rate would result in a parasitic loss of about 0.8% of the fuel cell power.)

However, the actual inefficiencies can be expected to be higher. The coulombic efficiency of the carbon dioxide ejection is generally significantly less than 100% in concentrated alkaline solutions. In fact, normally, the predominant reaction is the simple side reaction:

H⁺+OH³¹ →H₂O <Reaction 6>

The ejection of carbon dioxide from carbonated solutions of highly concentrated alkaline electrolyte (6M KOH for MHFC) requires a massive pH gradient. The formation and decomposition of carbonic acid (Reactions 3 and 4) require the pH to drop from 14 to less than 7, representing more than 7 orders of magnitude in hydrogen ion concentration. Furthermore, the hydroxide ion reactant concentration for the side reaction (Reaction 6) is about an order of magnitude higher than desired to control the carbonate ion concentration.

### Preliminary Experiments

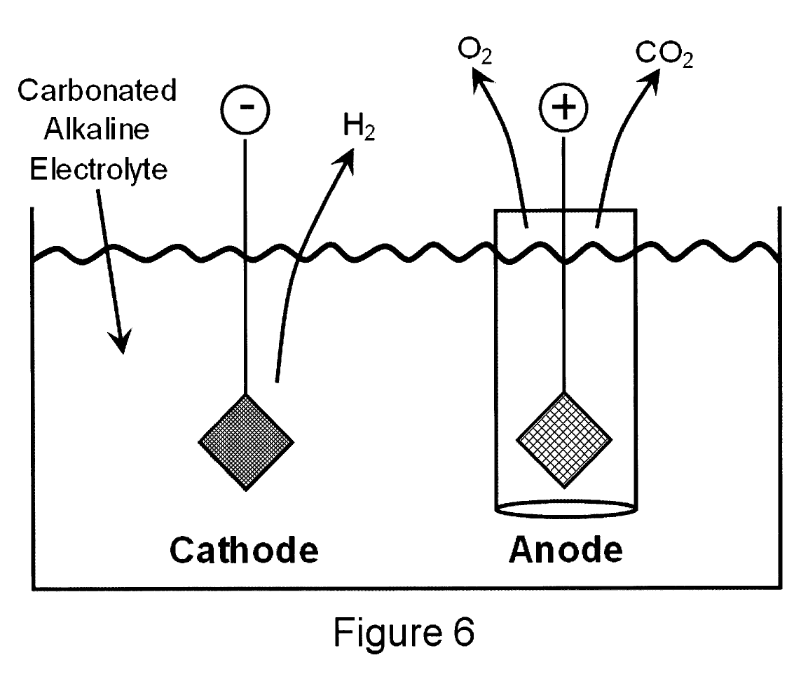

Preliminary experiments were set up as shown in FIG. 6. In a preliminary beaker-scale experiment, measurements on the electrolysis of a carbonated solution of concentrated alkaline electrolyte (2M K₂CO₃, 5M KOH) were performed. A nickel anode was enclosed in a small glass tube to create the pH gradient driving force. After electrolysis at an average of 15 mA for 450 hours, the carbonate concentration was reduced from 2M to 1.4M. About 1.1 g of CO₂ was removed from 40 cc of carbonated electrolyte with the expenditure of 20 Wh of energy yielding an ejection efficiency of 0.05 g/Wh. The efficiency was impacted by a cell voltage of about 3 V, which can be improved by cell design to about 2V. Ejection efficiencies also were observed to increase at increased anodic current densities and decrease as the carbonate concentration declines. The long electrolysis time can be reduced by increasing the ratio of electrolysis power to total electrolyte volume.

Additional preliminary experiments were performed using a microporous PVC battery separator to enclose the bottom of the anode chamber. (This time larger electrodes and a larger anode chamber relative to the total electrolyte volume were used.) Starting with 200 cc of carbonated electrolyte (2M K2CO3, 3.5 M KOH), the total carbonate concentration was reduced from 2.1 M to 1.8 M by electrolysis at 0.9 A and 4.2 V over 27 hours, translating to a CO₂ ejection efficiency of 0.025 g/Wh.

In proof of concept experiments, the inventors were able to demonstrate 0.05 g/Wh ejection of CO₂ from concentrated KOH solutions with 2M K₂CO₃ present. At this efficiency, electrochemical CO₂ ejection would translate to a parasitic loss of about 5% of the fuel cell power output, acceptable for some applications. However, higher efficiencies are desirable and may be needed in scaled up systems.

### Electrochemical Electrolyte Regeneration (EER) Solution

One embodiment of the present invention utilizes an electrolysis device to remove carbon dioxide from the MHFC alkaline electrolyte as the carbonate accumulates. Ambient air would be input directly into the fuel cell where trace carbon dioxide would be absorbed into the alkaline KOH electrolyte. The subsequent removal of carbon dioxide from the electrolyte by the scrubber device is aimed at moderating the degree of electrolyte carbonation to levels the MHFC stack can tolerate without performance degradation.

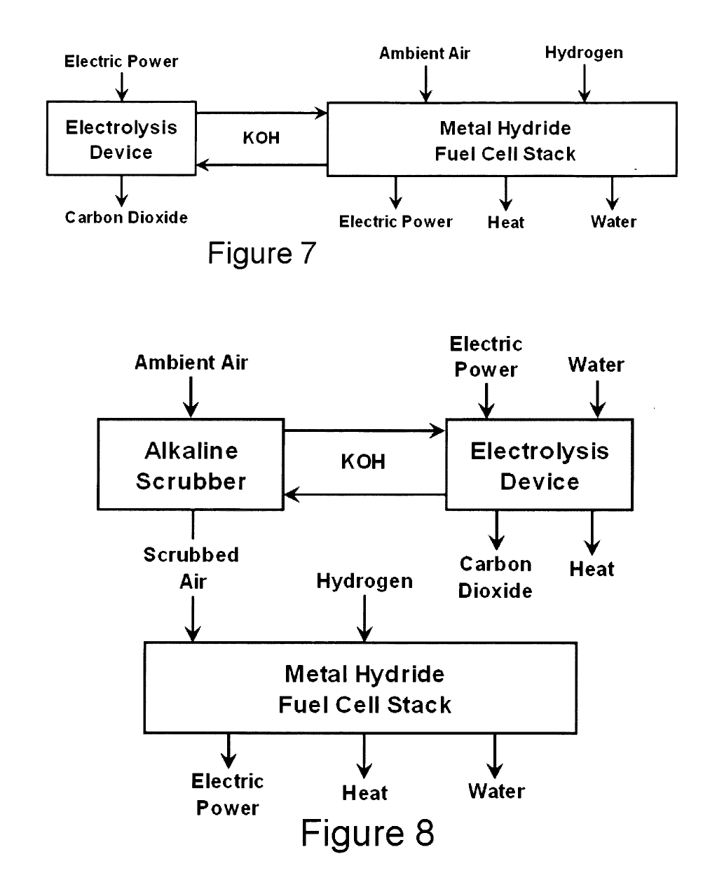

The block diagram in FIG. 7 shows KOH electrolyte interchange between the MHFC stack and the electrolysis device, which can be incorporated into the system electrolyte reservoir, potentially contributing very little additional volume or weight beyond the original circulated electrolyte fuel cell system. The electrolyzer consumes water. However, since the electrolyte is common with the fuel cell, it can utilize product water from the fuel cell and a common water management approach. This embodiment would also include collection of hydrogen generated from electrolysis and storage for subsequent utilization in the fuel cell.

### Electrochemically Regenerative Scrubber (ERS) Solution

An alternative embodiment of the present invention utilizes an electrolysis device to regenerate an alkaline electrolyte air scrubber. In this approach, the MHFC stack is supplied with scrubbed air. This is a more complicated approach, but has the advantage of avoiding carbonation of the fuel cell electrolyte altogether. It also provides more flexibility in the design because the composition and concentration of the alkaline electrolyte in the scrubber can be adjusted to optimize the efficiency of the electrolysis device.

This concept is illustrated in the block diagram in FIG. 8. The scrubber contains alkaline electrolyte independent of the fuel cell electrolyte that is regenerated through interchange with the electrolysis device. This embodiment would also include collection of hydrogen generated from electrolysis and storage for subsequent utilization in the fuel cell. Product water from the fuel cell could also be used as a reactant for the electrolyzer.

### Synergistic Systems Solutions for UPS/Emergency Power Applications

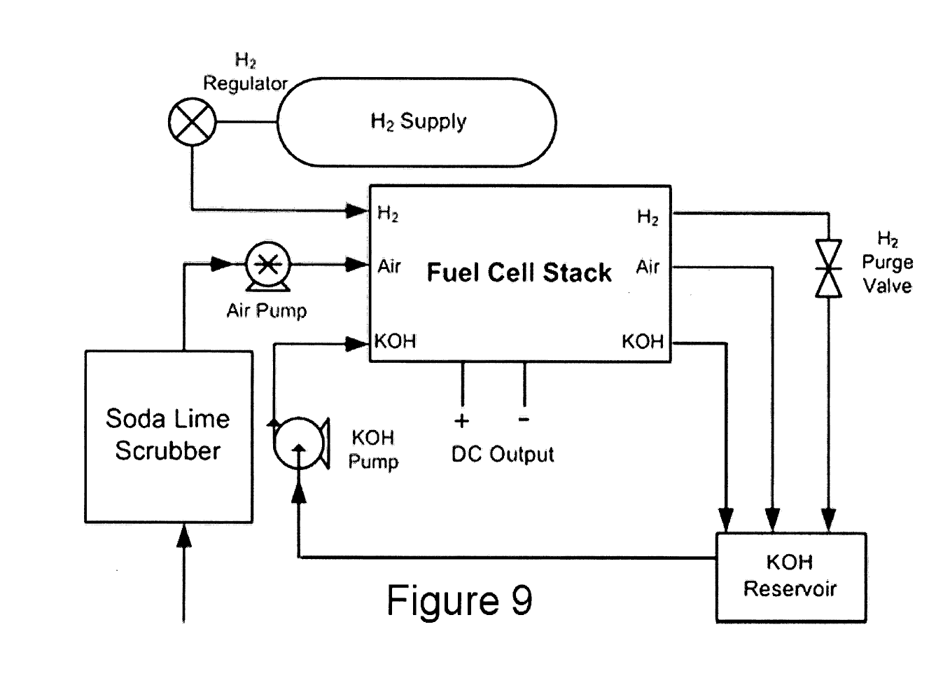

The overall design of a MHFC system for UPS/emergency power applications is diagrammed in FIG. 9. The inventors objective was to replace the large soda lime scrubber which removes CO₂ from the input air. Hydrogen is typically supplied by a canister. The KOH electrolyte is circulated through the fuel cell stack for heat removal (not shown) and water management through evaporation and/or condensation processes (not shown). Product water in the air and hydrogen streams are collected in a KOH reservoir.

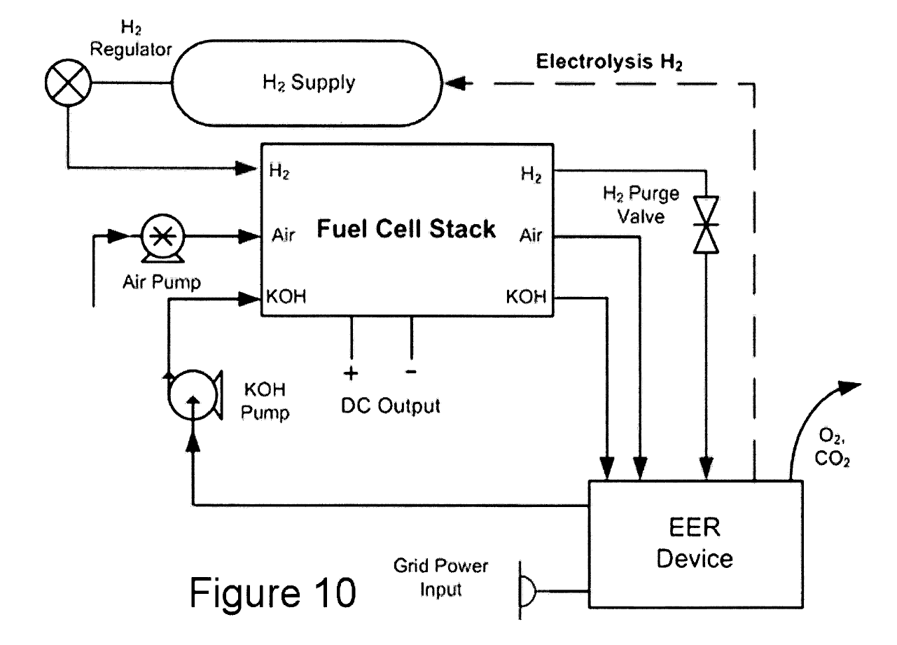

Integration of the present Electrochemical Electrolyte Regeneration (EER) device into the MHFC fuel cell system provides an elegant simplification and improvement of the design as shown in FIG. 10. The EER device eliminates the need for the large soda lime scrubber and can be integrated into the electrolyte reservoir vessel. The sharing of a common electrolyte between the EER device and the stack enables a simple integrated approach to water management and thermal management. In addition to controlling the electrolyte carbonate concentration to acceptable levels by ejection of CO₂, the EER device provides a means to supply hydrogen utilizing grid electricity.

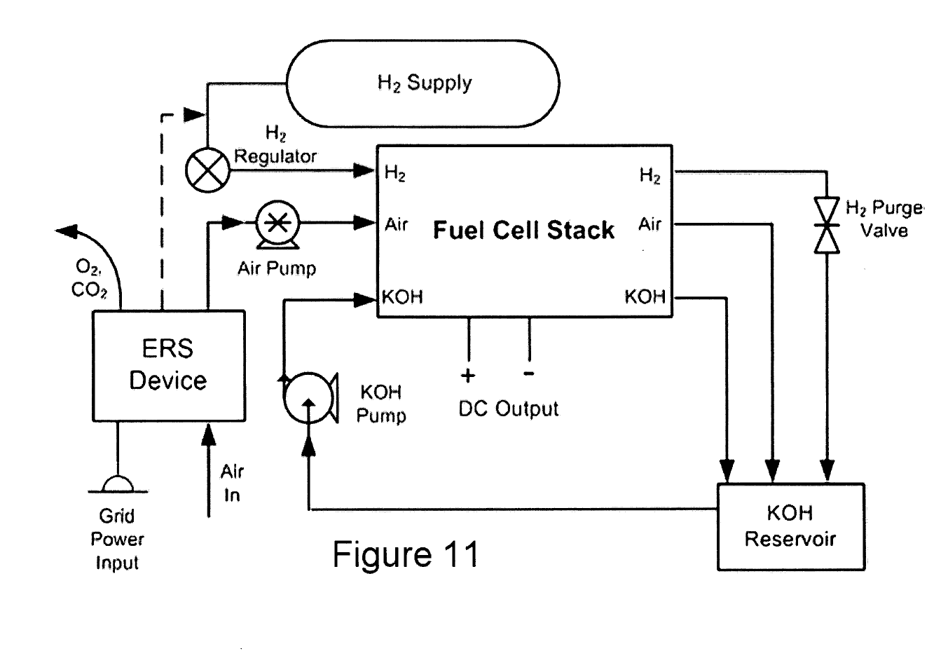

While the EER device is one preferred embodiment, the present Electrochemically Regenerative Scrubber (ERS) device provides an alternative that may ultimately prove more effective for other AFC technologies and/or other applications. Systems integration of the ERS device facilitates replacement of the large soda lime scrubber as shown in FIG. 11. Since the KOH utilized in the ERS device is independent of the fuel cell electrolyte, there is more design flexibility for development of the electrolyte composition and operating conditions such as temperature in this case. However, this design is also more complex and will require independent water management and thermal management in the ERS device system component.

The power to operate the EER and ERS electrolysis devices will translate to a parasitic loss for the fuel cell system of about 3% assuming 0.1 g/Wh CO2 ejection efficiency. For the UPS/emergency power applications, overall energy efficiency is much less important than the fuel cell system run time. Since the fuel cell system is installed to back up the electrical grid, grid electricity is available to maintain the system between power outages. Thus, our systems concept assumes the electrolysis devices will be powered by grid electricity, where conceivably losses as high as 5-10% could be tolerated.

The electrolysis devices proposed to deal with the carbon dioxide issue also offer a means to generate hydrogen using grid electricity. This is particularly useful for the UPS/emergency power application in order to avoid the cost and inconvenience of replacing hydrogen cylinders. More generally, electrolysis integrated to fuel cell systems provides a way to deal with serious hydrogen infrastructure issues facing most fuel cell applications.

Electrolysis is performed to produce hydrogen using grid electricity when the fuel cell back up power system is not in operation. The hydrogen needs to be stored at high pressure to be useful. Commercial hydrogen cylinders store hydrogen at about 2000 psi. Solid state hydrogen storage devices using metal hydride technology are available which can store hydrogen more compactly and require an input pressure of only 100-500 psi.

Electrolysis is an energy efficient method to compress hydrogen as well as generate it, and alkaline electrolysis devices have demonstrated capabilities in excess of 10000 psi. Alternatively, hydrogen can also be compressed or boosted with metal hydride based compressors based on thermal cycles.

Finally, hydrogen generated can be used to directly power the fuel cell and provide electricity to run the electrolyzer, thereby indirectly increasing the efficiency of the electrolysis device by about a factor of two.

While the discussion above indicates the use of a KOH solution as the scrubbing medium for the air scrubber, other soluble hydroxides such as NaOH, LiOH, etc, and mixtures thereof may be used. Further, neutral salts may be added to the scrubbing solution to increase the conductivity thereof without effecting the pH thereof. Examples of such neutral salts include halides, nitrates, sulfates, phosphates, etc. The particular salt used is not as important as the enhanced ionic conductivity that the salt provides.

### Pulses of Current

It may be advantageous in the present scrubbing systems to apply highest current possible before reaching the limiting current when the concentration of OH⁻=0 at the electrode/solution interface. Na₂CO₃ at the surface reacts in acidic media to release CO₂. In order to avoid high polarization at the interface when it is depleted from OH₋ ions and the voltage increases to high values (4-5 volts), a pulsating technique should be applied where the concentration of OH⁻ at the surface is kept at zero and the diffusion layer (concentration gradient layer) in the solution is narrow and does not continuously extended along the entire solution.

Alternatively the scrubbing solution may be stirred so that mass transfer will be high and polarization will not be too high (while using the highest possible current so that OH⁻ concentration will be 0 at the interface between the scrubbing solution and the CO₂ evolving electrode).

### Electrode Catalysts

One type of catalyst particularly useful for the electrodes of the present invention completely lack noble metals such as palladium or platinum. The catalysts useful in the electrodes of the present invention comprises a metal particulate, and a support. The particulate may be affixed to the surface of the support. Alternately, the particulate may be partially or totally embedded into the support. The metal particulate is a plurality of metal particles. Preferably, each metal particle may be a substantially pure elemental metal, or it may be an alloy of two or more elemental metals. It is also possible that one or more of the individual particles may be a composite or mixture of two or more elemental metals, two or more alloys, or an elemental metal and an alloy. All of the particles may have the same composition or they may be a mixture of particles with different compositions. Also, some of the particles may be substantially pure elemental metals while others may be alloys of two or more elemental metals

In one preferred embodiment, the catalyst lacks both platinum and palladium. Hence, there are no platinum particles or palladium particles. As well, none of the metal particles comprise either platinum or palladium as part of an alloy, composite or mixture.

In another embodiment of the present invention, the metal particulate comprises nickel particles and/or nickel alloy particles. The nickel alloy includes nickel and at least one additional elemental metal. Preferably, the at least one additional elemental metal may be any elemental metal except for either platinum or palladium. (Hence, it is preferable that the nickel alloy lacks both platinum and palladium). More preferably, the at least one additional elemental metal is selected from the group consisting of Al, Co, Sn, Mn, Ti and Fe. Most preferably, the at least one additional elemental metal is selected from the group consisting of Al, Co, Sn, Mn, and Ti. Examples of nickel alloys which may be used include nickel alloys comprising Ni and Co; nickel alloys comprising Ni, Co and Al; nickel alloys comprising Ni, Co, Mn and Ti; nickel alloys comprising Ni, Co, Mn and Fe; and nickel alloys comprising Ni and Mn. Specific examples of nickel alloys include a NiCo alloy, a NiCoAl alloy, a NiCoMnTi alloy, a NiCoMnFe alloy, and a NiMn alloy.

It is believed that the addition of modifier elements to the nickel to form a nickel alloy increases the surface roughness of the metal particles. Since surface roughness is the total surface area divided by the geometric surface area, the increased roughness provides for an increase in the total surface area of the metal particulate. The increased surface area provides for an increase in the number of active catalysis sites (i.e., there is increased accessibility to the catalytic material). Hence, the catalytic activity of the material is increased.

The increased surface area also makes the catalytic material less easy to poison. This is a crucial factor in the commercial viability of electrodes. Generally, poisoning is reduced as the number of active catalysis sites increases. As just discussed, this occurs with increased surface roughness and surface area. (It is noted that surface area can also be increased in other ways besides increasing surface roughness. For example, surface area may be increased by making the metal catalytic particles smaller and packing them closer together. This will also decrease the chance of the poisoning).

The addition of modifier elements to the metallic nickel can also inhibit poisoning in other ways. Poisoning can be affected by the actual composition of the metallic particulate. By identifying the poison and the mechanism for poisoning, a suitable modifier may be added to the metal particulate to combat the poisoning. For example, poisoning may be due to the build-up of a passivating oxide on the surface of the metal particulate. In this case, a modifier element such as cobalt or aluminum could be added at a concentration which is effective to provide an ongoing leaching of the particulate by the electrolyte in order to constantly provide a clean, new metallic surface which is free of the passivating oxide.

Also, poisoning may be due to the corrosion of the particulate and/or its support by the electrolyte. In this case a passivating agent, such as Zr or Mn, could be added. Though not wishing to be bound by theory, it is possible that these modified catalysts may be especially resistant to contaminants.

It is also believed that adding certain elements, such as Al, Sn and Co, to the nickel to form the nickel alloy may actually inhibit the growth of the alloy particles and cause the average size of the particles to remain small. As discussed above, decreasing the particle size while packing the particles closer together increases the total surface area of the particulate, increasing catalytic activity and decreasing the possibility of poisoning.

The catalytic metal particles of the present invention are not limited to any particular shape. They may be regularly shaped or irregularly shaped. Examples of particle shapes include spherical, elongated, thread-like, and “sponge-like”. “Sponge-like”, porous particles may be made by initially including in the metal particulate a modifier element, such as aluminum, whose sole purpose is to be leached out so as to leave the catalyst particulate with a sponge-like shape and a high surface area. The leaching step may be carried out by subjecting the alloy to an aqueous solution of an alkali metal hydroxide such as potassium hydroxide, lithium hydroxide, sodium hydroxide, or mixtures thereof. Preferably, the leaching may be done in a highly concentrated KOH solution (perhaps about 45 wt % to about 60 wt %), at elevated temperature of about 80° C. to about 120° C., for a time of about one hour to about four hours. Of course, other leaching conditions are also possible. After the leaching step, the remaining insoluble component forms a particulate with a sponge-like, porous structure. The increased porosity increases the surface area of the particulate.

It is noted that the catalytic activity of a material may be determined by measuring the material's exchange current Iₒ (measured in mA/g). The exchange current Iₒ is a function of both the material's exchange current density iₒ (measured in mA/m.sup.2) as well as the material's surface area A (m²/g). Specifically, the exchange current, the exchange current density and the surface area are all related as follows:

Iₒ=iₒ×A

This equation shows that the total catalytic activity of a material (as measured by the total exchange current Iₒ) is a function of both the catalytic activity of the material composition (as measured by the exchange current density iₒ) as well as the surface area of the material A. Hence, the total catalytic activity of a material may be increased by either appropriately changing its composition to one which is more catalytic or by increasing its effective surface area. As discussed above, the effective surface area may be increased by increasing the porosity and/or roughness of the catalytic particles. It also may be increased by using a larger number of smaller-sized particles, and by packing these smaller-sized particles closer together. The effective surface area may also be increased by increasing the porosity and surface area of the support upon which active material is dispersed. The support will be discussed in more detail below.

Preferably, the catalytic metal particles of the present invention have a very small particle size. Specifically, the particles have an average particle size which is preferably less than about 100 Angstroms, more preferably less than about 70 Angstroms, and most preferably less than about 50 Angstroms. In addition, the particles may have an average particle size which is preferably be less than about 40 Angstroms and more preferably may have an average particle size which is less than about 30 Angstroms. In addition, the particulate may have a particle size between about 10 to about 70 Angstroms, preferably between about 10 to about 50 Angstroms, more preferably between about 10 to about 40 Angstroms and most preferably between about 10 and about 30 Angstroms.

A key aspect of the instant invention is the disclosure of a practical embodiment and method of producing “ultra fine catalysts”. Since the catalytic properties of a material are primarily a surface property (rather than a bulk property), large catalytic metal particles essentially waste the interior metallic atoms. For expensive elements, such as platinum and palladium well known to have the required stability for electrode use), this waste of material provides an unacceptable cost. Therefore, the smaller the metallic particles, the better since the surface area for catalysis rises proportionally. It is extremely difficult to produce Angstrom size metallic particles. Hence, the disclosure of 10-50 Angstrom size particles (which themselves may have additional surface area due to surface roughness) in a finely divided distribution within an inexpensive support is unique.

In certain embodiments of the present invention, the metal particles of the present invention are situated in close proximity to one another so that the particulate has a high density. (Hence, there is also a high density of catalytic activity). The particulate may have an average proximity that is preferably between about 2 and about 300 Angstroms, and more preferably between about 50 to about 100 Angstroms.

In other embodiments of the invention the percentage weight of the metal may be varied so that the metal particulate is preferably between about 0.0001% to about 99% by weight of the catalyst, more preferably between about 0.001% to about 99% by weight of the catalyst, most preferably between about 0.01% to about 99% by weight of the catalyst.

Experimental observations from high resolution scanning transmission electron microscopy (STEM) of specific embodiments of thist catalytic material show the presence of catalytic regions or “catalytic clouds”. These catalytic regions may comprise nickel and/or nickel alloy regions. The nickel or nickel alloy regions may be regions of metallic nickel particles and/or nickel alloy particles having an average size of about 10 to about 30 Angstroms in diameter. In some of these regions, the proximity between the particles may be between about 10 to about 50 Angstroms. In other regions, the metallic nickel and/or nickel alloy particles are even more closely packed, having a proximity on the order of about 10 to about 20 Angstroms.

Preferably, the metal particulate of the present invention is “stable” over time. That is, preferably, the size of the particles remains small and does not increase over time. This helps to ensure that the total surface area of the particulate remains stable (i.e., does not decrease) over time.

The catalyst of the present invention further comprises a support for the metal particulate. Generally, any support conventionally known in the art, capable of supporting and providing adequate dispersion for the particulate, may be used. Preferably, the support should be inexpensive and stable in the local environment in which it is being used. The support used preferably has a surface area and/or porosity sufficient to provide an adequate dispersion of the metal particles

Increasing the porosity of the support also provides for a more intimate contact between the hydrogen gas reactant and the catalytic material. In the case of a liquid electrolyte, it also enhances the contact between the electrolyte and the catalytic particles thereby improving or optimizing proton transfer. Generally, the metal particulate may be affixed to the surface of a support and/or partially embedded in the support and/or totally imbedded in the support.

These catalytic materials also facilitate introduction of an electrolyte impermeable membrane in combination with a current collection substrate such as wire mesh or expanded metal.

In one embodiment of the present invention, the support comprises one or more inorganic oxides. The inorganic oxides may be metal oxides. The oxides may comprise at least one element selected from the group consisting of nickel, cobalt, manganese, titanium, zirconium, iron and the rare earth elements. The oxides may comprise one or more individual oxides of the elements nickel, cobalt, manganese, titanium, zirconium, iron and the rare earth elements. Alternately, the oxides may comprise one or more oxides of alloys formed from two or more of the elements nickel, cobalt, manganese, titanium, zirconium, iron and the rare earth elements.

In a first example, the support comprises an oxide of manganese. In a second example, the support comprises an oxide of nickel and manganese. In a third example, the support comprises an oxide of nickel, manganese, cobalt, and titanium. In a fourth example, the support comprises an oxide of nickel, manganese, cobalt, titanium and iron. In a fifth example, the support comprises an oxide of nickel, manganese, cobalt and titanium. In a sixth example, the support comprises an oxide of titanium and zirconium. In a seventh example the support comprises silica. In an eighth example, the support comprises alumina. The metal particulate may be affixed to the surface of the oxide support. Alternately, the metal particulate may be at least partially embedded within the oxide support, or it may be totally embedded within the oxide support.

In still another embodiment, these ultra-fine catalysts may be combined with zeolite materials. The zeolites may have variable metal to silicon ratios, and the ratio of the catalyst to zeolite may also vary. A combination of catalyst/support oxide/zeolite is a preferred embodiment.

The oxide support may itself be catalytic. In fact, by using certain oxides as the support material, regions of exceptionally high catalytic activity may be formed, especially at the double or triple or more junctions between the metallic particle and the support oxide where designed regions of hydrophobic or hydrophilic property may be formed. Analytical studies show that these regions are rich in such elements as nickel, cobalt, manganese and titanium, and are referred to herein as “NiCoMnTi super catalytic regions”. It is believed that these super catalytic regions may consist of nickel-manganese alloy particles embedded in a titanium-zirconium oxide. These super catalytic regions show a surprising lack of oxygen (based on the results of Electron Energy Loss Spectroscopy-EELS). It is also believed that the oxide portion of these regions may be partially metallic and/or exist in a low oxidation state.

The oxide support also may be formed from metal oxides which are “microcrystalline” in structure, having crystallites of very small size. Because of their small crystallite size, these oxides have an increased number of grain boundaries which provide “ionic pathways” for both hydrogen and hydroxyl ions. (These ionic pathways may permit the hydrogen and hydroxyl ions to move more freely to the metallic nickel or nickel alloy catalytic sites which may be situated in the grain boundaries). Hence, such oxides facilitate ionic transport through the catalytic material.

Alternately, the oxide support may be formed so that it at least partially comprises a “multivalent” oxide material such as manganese oxide, MnOₓ. Because manganese oxide is multivalent, it is believed that it may further promote increased catalytic activity by changing oxidation states.

It is also possible to add a polymeric material to the oxide support in order to modify the hydrophobic/hydrophilic nature of the catalyst bed. Examples of such polymers include fluropolymers such as polytetrafluoroethylene (PTFE).

The oxide support may comprise fine-grained oxides, coarse-grained oxides or a mixture of fine-grained ox-des and coarse-grained oxides. Alternately, the oxide support may be formed so that it comprises a “multi-phase” oxide material. For example, the oxide may be formed so that it includes both fine-grained and coarse-grained regions. The fine-grained region may include oxides such as a manganese oxide MnOₓ, a NiMnCoTi oxide or a MnCoTi oxide. One advantage of a multiphase oxide may be the suitable structural integrity of the electrode to withstand the rigors of transportation where vibration can cause premature failure. The coarse-grained regions may include oxides such as a TiZr oxide.

The catalytic materials of the present invention may be formed so that the metal particles have certain crystal structures (based on Select Area Electron Diffraction —SAED) within the oxide support. For example, catalytic materials comprising nickel alloy particles embedded within an oxide material may be formed so that the alloy particles have a face-center-cubic (fcc) structure. The formation of an fcc crystal structure may be influenced by the high degree of substitution of the modifier elements (such as Co, Al, Mn, Sn) for the nickel. The fcc nickel alloy in conjunction with the NiCoMnTi super catalytic regions and the TiZr oxide forms a structure which may further promote ionic diffusion and reaction. In an alternate embodiment, the support may be formed from a carbon material. Examples of carbon supports include carbon black, graphite, activated carbon, charcoal and carbine. Mixtures of carbon materials and inorganic oxides may also be used. Alternately, the support may comprise a carbide. For example, the support may comprise a binary compound of carbon and another element. (Examples of carbides include those of calcium, tungsten, silicon, boron, and iron). Additionally, other mixtures or blends of supports can be used to provide high surface area for the catalytic metal particulate and good electronic conductivity as well as good ionic transport.

Alternately, the support may comprise a halide such as a chloride. Alternately, the support may comprise a phosphide, a silicide, or a nitride. Of course, the support may be a blend or mixture of the materials described above.

One of the starting materials for the formation of the catalytic materials of the present invention are hydrogen storage alloys. These are materials which are capable of the absorption and release of hydrogen. Hydrogen storage alloys are known in the art. Examples of very simple hydrogen storage alloys are the TiNi and LaNi₅ alloys. Other examples of hydrogen storage alloys are provided in U.S. Pat. No. 4,623,597 (the disclosure of which is incorporated by reference). The materials described in the '597 patent have a greatly increased density of catalytically active sites providing for the fast and stable storage and release of hydrogen. These materials were fabricated by manipulating the local chemical and structural order by incorporating selected modifier elements into a host matrix so as to create the desired disorder. Additional hydrogen storage alloys are disclosed in U.S. Pat. No. 4,551,400 (“the '400 patent”), the disclosure of which is incorporated by reference. These materials utilize a generic Ti—V—Ni composition where at least Ti, V, and Ni are present with at least one or more of Cr, Zr, and Al. Other Ti—Vi—Zr—Ni alloys are described in U.S. Pat. No. 4,728,586 (“the '586 patent”), the disclosure of which is incorporated by reference. The '586 patent described a specific sub-class of these Ti—V—Ni—Zr alloys comprising Ti, V, Zr, Ni, and a fifth component Cr. Modified LaNi₅ materials are discussed in U.S. Pat. No. 5,096,667, (“the '667 patent”) the contents of which is incorporated by reference herein. Still other examples of hydrogen storage alloys are described in U.S. Pat. Nos. 5,840,440, 5,536,591 (“the '591 patent”) and U.S. Pat. No. 6,270,719 (“the '719 patent”), the contents of which are all incorporated by reference herein.

Examples of alloys described in the '591 patent are alloys having the composition:

(Base Alloy)ₐCo_{b}Mn_{c}Fe_{d}Snₑ

where Base Alloy comprises 0.1 to 60 atomic percent Ti, 0.1 to 40 atomic percent Zr, 0 to 60 atomic percent V, 0.1 to 57 atomic percent Ni, and 0 to 56 atomic percent Cr; b is 0 to 7.5 atomic percent; c is 13 to 7 atomic percent; d is 0 to 3.5 atomic percent; e is 0 to 1.5 atomic percent; and a+b+c+d+e=100 atomic percent. Many of the alloys described in the '591 patent include Mn, the effects of which is discussed in the '667 patent, the disclosure of which is incorporated by reference herein.

The '719 patent describes certain hydrogen absorbing alloys formed by adding one or more modifier elements to certain “base” alloys. The base alloys preferably have a composition consisting essentially of 0.1 to 60% Ti, 0.1 to 40% Zr, 0 to 60% V, 0.1 to 57% Ni, 5 to 22% Mn and 0 to 56% Cr. The modified alloys which are described in the '719 patent are referred to herein as “the '719 alloys”.

Preferably, the modifying elements are chosen from the group consisting of Al, Co, Sn, and Fe. More preferably, the modifying elements are chosen from the group consisting of Al, Co, and Sn. In a first example, all three modifying elements, Al, Co, and Sn are added to the base alloy. In a second example, all four modifying elements, Al, Co, Sn and Fe are added to the base alloy.

In a third example, the modifier elements may added to the base alloy so that the atomic percentage of Al is between about 0.1 and about 10, the atomic percentage of the Co is between about 0.1 and about 10, the atomic percentage of the Sn is between about 0.1 and about 3.0, and the atomic percentage of the Fe is between about 0.0 and about 3.5. In a fourth example, the modifier elements may be added to the base alloy so that the resulting modified alloy has the following composition: Ti_{9.0} Zr_{26.2} V_{5.0} Ni_{38.0} Cr_{3.5} Co_{1.5} Mn_{15.6} Al_{0.4} Sn_{0.8}.

Hydrogen storage alloys tend to react with oxygen to form metal oxides by the reaction:

M+X/2O₂→MOₓ

Hydrogen storage alloys are sensitive to the formation of surface oxides so that most, if not all, of these alloys comprise an initial surface oxide layer. The composition of this initial surface oxide layer depends, at least in part, on the composition of the underlying bulk alloy material (that is, upon the constituent metals which make up the bulk material as well as the atomic percentage of those metals). The oxide surface layer is typically between about 50 Angstroms to about 1000 Angstroms thick, although thicknesses of the surface oxide layer of up to about 5000 Angstroms are possible.

The initial surface oxide of a hydrogen storage alloy may be modified by an etch process. Alkaline etch processes are described in U.S. Pat. No. 4,716,088 (“the '088 patent”) and U.S. Pat. No. 6,569,567(“the 567 patent”), both of which are incorporated herein by reference. As described in the '088 patent, the major role of the etch process is that of surface modification. All of the '088 patent, the 567 patent, the '591 patent and the '719 patent describe the effects of the etch process on the surface oxide.

A method of making the catalytic material of the present invention is by subjecting a hydrogen storage alloy starting material (which is preferably in the form of a powder) to a leaching process (also referred to herein as a “leaching treatment”). The leaching process of the present invention is a deep, penetrating “bulk” leaching process. This means that the leaching material (the active material that does the leaching also referred to as “leaching agent” or “leachant”) penetrates well below the 5000 Angstrom initial surface oxide layer of the alloy particle and into the particle bulk. As used herein, “bulk” refers to the interior region of the particle beneath the 5000 Angstrom oxide surface layer. The leaching process penetrates and treats (i.e., leaches) at least a significant portion of the bulk of the alloy particle. Preferably, a significant portion of the bulk is leached when the leaching process treats at least about 10,000 Angstroms of the hydrogen storage alloy particle. Hence, it is preferable that at least about a 10,000 Angstrom thick layer of the hydrogen storage alloy particle is leached. More preferably, at least about 20,000 Angstroms of the particle is leached. Most preferably, at least about 30,000 Angstroms of the particle is leached. In another embodiment of the method, it is preferable to leach at least about 40,000 Angstroms of the particle. It is more preferable to leach at least about 50,000 Angstroms of the particle. In a preferred embodiment of the method, it is preferable to leach substantially the entire bulk of the hydrogen storage alloy material. Hence, in a preferred embodiment, substantially the entire hydrogen storage alloy particle is leached.

In other embodiments of the instant invention preferably at least about 10% of the hydrogen storage alloy particle is leached, more preferably at least about 25% of the hydrogen storage alloy particle is leached, and most preferably at least about 50% of the hydrogen storage alloy particle is leached. In yet other embodiment of the instant invention preferably at least about 75% of the hydrogen storage alloy particle is leached, and more preferably at least about 90% of the hydrogen storage alloy particle is leached.

As described above, an embodiment of the instant catalytic materials is a finely divided metal particulate embedded in an oxide support. In particular, the metal particulate may be a metallic nickel and/or a nickel alloy where the nickel alloy lacks both platinum and palladium. This embodiment may be made by subjecting the hydrogen storage alloy material to the appropriate leaching process. The leaching process penetrates into substantially the entire particle bulk and converts the oxidizable components of substantially the entire bulk of the alloy particle to oxides. Hence, the oxidizable components of substantially the entire alloy particle in converted to oxides.

The hydrogen storage alloy may be subjected to a leaching process by “contacting” the alloy material with an appropriate leaching material for a predetermined period of time, at a specific temperature and at a specific pH. To convert the alloy material to oxide, the appropriate leaching material may be an alkaline solution. The hydrogen storage alloy may be “contacted” with the alkaline solution by placing the alloy (which is preferably in powder form) in a container of the alkaline solution. The alkaline solution is preferably formed as an aqueous solution of an alkali metal hydroxide. Examples of alkali metal hydroxides which may be used include potassium hydroxide, sodium hydroxide, lithium hydroxide, and mixtures thereof. The pH of the alkaline solution may be adjusted by changing its alkaline concentration. The alkaline concentration is adjusted by changing the percentage weight of the alkali metal hydroxide added to the aqueous solution. The period of time in which the leaching material (i.e, in this case, the alkaline solution) is in contact with the hydrogen storage alloy, as well as the temperature and pH of the leaching agent are all result-effective variables which can be varied to effect the outcome of the leaching process.

Many of the metallic components within the bulk of the alloy are readily oxidized by the concentrated alkaline solution of the leaching process. However, some of the metallic elements and/or alloys within the bulk of the alloy are resistant to oxidation by the alkaline solution. By choosing an appropriate starting alloy and then subjecting this starting alloy to the alkaline solution for a certain period of time and at a certain temperature and pH, it is possible to convert the oxidizable components to oxides. However, some of the metallic components and/or alloy components are resistance to oxidation by the alkaline solution and are not converted oxides. In fact, by carefully selecting the appropriate starting hydrogen storage alloy as well as the appropriate leaching conditions, the starting alloy may be leached so that substantially all of the oxidizable components of the hydrogen storage alloy material are converted to oxides. Those components which are resistant to oxidation will remain as metallic elements or alloys.

Hence, in a preferred embodiment of the catalytic material may be formed by selecting an appropriate starting hydrogen storage alloy material and then leaching the material with the appropriate leaching material and under the appropriate conditions (i.e., time, temperature and pH) until substantially all of the oxidizable components of the starting hydrogen storage alloy are converted to oxides (i.e., so that substantially none of the oxidizable components of the hydrogen storage alloy remain). This “completely oxidized” material includes a finely divided, highly catalytic metal and/or alloy particulate (which is preferably nickel and/or nickel alloy) that, as discussed above, is resistant to conversion to oxide by the alkaline solution. The oxidized material with metal particulate may be referred to herein as a “catalytic oxide”. The metal particulate may be extremely small. As discussed the particles may be made which have an average particle size which is preferably less than about 100 Angstroms, more preferably less than about 70 Angstroms, and most preferably less than about 50 Angstroms. In addition, in certain embodiments of the present invention the particulate may have a particle size between about 10 to about 70 Angstroms, preferably between about 10 to about 50 Angstroms, more preferably between about 10 to about 40 Angstroms, most preferably between about 10 to about 30 Angstroms.

Hence, the leaching process provides a cost effective way to make a catalytic material comprising metallic nickel and/or nickel alloy particles having an extremely small particle size (i.e., ultra-fine metallic catalysts). It is noted that if one wished to make the same size nickel or nickel alloy particles using metallurgical means it would either not be possible, or if possible, would be cost prohibitive. In particular, it is noted that background art U.S. Pat. No. 4,541,905 to Kuwana, et al. (“the '905 patent”) describes a catalytic material formed by the electrodeposition of nickel into a polymeric layer. In contrast to the instant catalytic materials, the catalytic material of the '905 patent comprises nickel oxide rather than elemental metallic nickel. Likewise background art U.S. Pat. No. 5,053,379 to Giordano, a et al. (“the '379 patent”) also describes a nickel catalyst made by subjecting a nickel compound carrier to a thermal decomposition treatment. In contrast to the present catalyst, the Ni/MgO catalyst of the '379 patent also consists of nickel oxide rather than metallic nickel.

In addition to converting essentially all of the oxidizable components of the hydrogen storage alloy material to oxides, the leaching treatment may also alter the composition of the oxides. The alkaline solution may do this by dissolving the more soluble oxide components out of the oxide portion. Certain oxides are more soluble than others in an alkaline environment. For example, the oxides of manganese, vanadium, aluminum, cobalt and tin are readily soluble in an alkaline solution while others, such as those of titanium, zirconium and nickel are less soluble. Those oxides which are more soluble will be removed from the oxide layer to the alkaline solution. The less soluble oxides will either remain at part of the oxide or enter the alkaline solution as colloidal particles. Hence, the composition of the oxide portion will be altered.

Selectively removing the more soluble components of the oxide portion of the catalytic material provides for a greater concentration catalytic sites of metallic nickel and/or nickel alloy, which are resistant to oxidation and also insoluble in the alkaline solution. Nickel and nickel alloys, in their metallic state, are catalytic and electrically conductive, and these catalytic properties are imparted to the oxide region. The oxide region is thus more catalytic and conductive than if it contained a higher concentration of insulating oxides.

Removing the more soluble oxide components also makes the oxide region more porous. An increase in porosity increases the permeability of the oxide region to the diffusion and transport of molecular hydrogen as well as to the diffusion and transport of certain ions, such as hydrogen and hydroxyl ions. An increase in porosity also increases the surface area of the oxide region.

It is noted that the bulk leaching process used to create the catalytic materials is distinguishable from alkaline “etching” treatments used to simply modify the initial surface oxide layer (described above) of the hydrogen storage alloy. As discussed above, this initial surface layer is about 1000 Angstroms thick. Alkaline etch treatments described in the '088 patent as well as the '391 application, are surface treatments used to modify the existing surface oxide of a hydrogen storage alloy material in order to make the material suitable for use as the active electrode material in a metal hydride electrochemical cell (for example, a nickel metal hydride cell). When used as the active material for an electrochemical cell, the hydrogen storage alloy particles themselves may be on the order of about 10 to about 70 microns in size. After the etch treatment, each hydrogen storage alloy particle is surrounded by a relatively thin metal oxide surface layer that may have a thickness of about 1000 Angstroms. Within this oxide surface layer, there are a large number of the metallic nickel and/or nickel alloy particles that are on the order of about 10 to about 70 Angstroms in size. Overall, however, the fraction of the catalytic metal particles in the thin oxide surface layer is small in comparison to the volume of metal present in the non-oxidized bulk of the hydrogen storage alloy particles.

In contrast, as discussed above, the leaching process used to form the catalytic material of the present invention preferably oxidizes substantially all of the starting hydrogen storage alloy particle. Leaching conditions (i.e., leaching time as well as temperature and pH of the leaching material) are selected which completely treat the starting hydrogen absorbing alloy particles so that only oxides with suspended catalytic particles remain (i.e, a “catalytic oxide”). The leaching conditions used to make the catalytic materials may be different from those used to activate the hydrogen storage alloy materials for battery applications (i.e., since at least a significant portion of the bulk will be leached, one or more of the leaching conditions may be more aggressive). Also, the selection of the starting hydrogen storage alloy itself may also be different for the instant catalysts than the starting material used to form an active electrode material for battery applications. For example, the chosen hydrogen storage alloy for the instant catalyst may use a higher fraction of readily dissolved elements such as V, Co, Al, and Sn.

Specifically, to form the catalytic materials of the present invention, the leaching material may be an alkaline material and the leaching conditions may be chosen so that the temperature of the alkaline material is preferably above about 60° C., and more preferably above about 100° C. The percentage weight of the alkali metal hydroxide is preferably at least about 30 weight %, more preferably at least about 40 weight %, and most preferably at least about 60 weight %. Of course, the leaching conditions are not limited to the above ranges and may be varied to achieve the desired results.

In another embodiment of the method of making the catalytic materials, the leaching material used may be an acidic solution. The acidic solution may be an aqueous solution of one or more acids. Examples of acids which may be used include HF, HCl, H₂SO₄, and HNO₃. Blends of two or more acids may also be used. An example of a blend which may be used is an aqua regia. An example of an aqua regia is a mixture of nitric acid and hydrochloric acid. The leaching process may be implemented by “contacting” the alloy material with an acid (such as HF) for a predetermined period of time, at a specific temperature and at a specific pH.

It is also possible that the desired catalytic materials be made by using two or more leaching processes. For example, a first alkaline leaching treatment may be performed at a first set of leaching conditions (i.e., a first alkaline material as well as a first time, temperature and alkaline concentration), and then a second alkaline leaching treatment may be performed at a second set of etch conditions (i.e., a second alkaline material as well as a second time, temperature and alkaline concentration). This process may be repeated with further, subsequently applied, alkaline leaching treatment. Alternately, one or more of the alkaline leaching treatment may be replaced with one or more acidic leaching processes (wherein the leaching material is an acidic solution). Hence, the leaching process may comprise two or more acidic etch treatments. Alternately, the leaching process may comprise one or more alkaline leaching treatment and one or more acidic leaching treatments. In a particular embodiment, the leaching process may comprise alternating alkaline leaching treatments and acidic leaching treatments. This alternating acid/base treatment is an especially aggressive method to more fully react the starting alloy.

Hence, by appropriately selecting the appropriate leaching conditions and/or the appropriate starting material, the leaching process may also be used to chemically convert a desired percentage of each of the hydrogen storage alloy particles to the catalytic oxide. Specifically, in another embodiment of the invention, it is preferable that the leaching process chemically converts at least about 10% of each of the alloy particles to the catalytic oxide. It is more preferable that the leaching process chemically converts at least about 25% of each of the alloy particles to the catalytic oxide. It is most preferable that the leaching process chemically converts at least about 50% of each of the alloy particles to the catalytic oxide. In another embodiment, the leaching conditions and/or the starting materials may be chosen so that the leaching process chemically converts at least about 75% of each of the alloy particles to the catalytic oxide. Preferably, the leaching process converts at least about 90% of each of the alloy particles to the catalytic oxide.

It is also possible that the catalyst may be “compositionally graded”. As used herein, compositional grading refers to forming the catalyst so that there is a continuous change (linear or non-linear) in some aspect of the composition in a chosen direction. (Preferably, there is a continuous increase or decrease in some aspect of the composition).

As discussed above, it is also possible to form a support which comprises materials other than oxides. For example, the support may also comprise chlorides, phosphides, silicides, nitrides and carbides. These materials may also be made using a deep, penetrating leaching process. The leaching material is appropriately chosen to convert the starting hydrogen storage alloy material to the desired support material. (Of course mixtures of materials may also be formed—with or without oxides). For example, a catalytic phosphide may be formed comprising a finely divided metal particulate embedded in a phosphide.

In an alternate embodiment, by selecting the appropriate starting material as well as an appropriate leaching process it is also possible extract (i.e., dissolve out) substantially all of the soluble oxide components of the starting material, leaving behind only the small, catalytically active particles. These catalytically active particles may be affixed to a support material or a support structure. For example, they may be mixed with a carbon support material. Alternately, they may be affixed to a support structure such as a conductive grid. Also, they be even be mixed together with a binder, such as PTFE, for mechanical stability.

In the embodiments of the leaching processes described above, the leaching process involved a chemical treatment of the hydrogen storage alloy powder. This may be referred to as “chemical leaching”. In an alternate embodiment of the leaching process, the leaching treatment may be electrochemically assisted. That is, a potential may be applied to the hydrogen storage alloy powder so as to make it easier to convert the oxidizable components of the alloy to their respective oxides or to remove the more soluble oxides from the material after the oxides are formed. This type of electrochemically assisted leaching is referred to herein as “electrochemical leaching”. The electrochemical leaching is similar in concept to electrochemically assisted etching (applying potential to assist the etching process) which is described in detail in the '088 Patent.

From the discussion above, it is seen that by first formulating a hydrogen absorbing alloy material with an appropriate composition and then subjecting this alloy to a leaching process having the appropriate leaching conditions (i.e., time of leaching as well as temperature and pH of the leaching material), substantially the entire starting alloy may be oxidized to form a highly catalytic material comprising a nickel and/or nickel alloy particulate embedded in an oxide support. Generally, by carefully choosing the starting alloy as well as the leaching conditions, this catalytic material may be designed to have the desired catalytic, electrochemical, and physical properties. As seen from the above discussion many different properties may be modified. These properties include, but are not limited to 1) the size, density, roughness and composition of the catalytically active sites, 2) the composition of the oxide support material, 3) crystal structure of the catalytic sites, 4) composition of the oxide support, 5) the grain size of the oxide support, 6) the surface area and porosity of the oxide, 7) the permeability of the oxide to gas and ionic transport (including, but not limited to, hydrogen and hydroxyl ion transport), and 8) the percentage of the hydrogen storage alloy particle converted to oxides.

It is noted that the catalytic materials of the present invention may also include disordered catalytic materials. Examples of disordered materials are provided in U.S. Pat. No. 4,487,818, the contents of which are incorporated by reference.

Relative comparisons of the efficiency of the present invention super catalysts versus that of platinum and palladium have not yet been done. It fact, it is still within the spirit and scope of the invention that even if worse than platinum and/or palladium, they may still be better. This is not only because these nickel catalysts are so much less expensive on a relative basis than either platinum or palladium, but also because the size and surface area can be made much smaller/higher respectively. The overall consequence is that the catalyst user has a higher available concentration per unit area of the catalyst available compared to either platinum or palladium. Further, the long term benefits other than cost may be the ability of these “ultra fine catalysts” to operate effectively in unusually hostile (i.e., poisoning) environments without degradation.

It is to be understood that the disclosure set forth herein is presented in the form of detailed embodiments described for the purpose of making a full and complete disclosure of the present invention, and that such details are not to be interpreted as limiting the true scope of this invention as set forth and defined in the appended claims.

We claim:

1. An emergency power system comprising:
a fuel cell; and
an electrochemically regenerated air scrubber which removes carbon dioxide from said air.

2. The emergency power system of claim 1, further including a source of fuel.

3. The emergency power system of claim 2, wherein said source of fuel is a source of hydrogen.

4. The emergency power system of claim 3, wherein said source of hydrogen comprises canisters of metal hydride storage materials.

5. The emergency power system of claim 1, wherein said fuel cell is an alkaline fuel cell.

6. The emergency power system of claim 5, further comprising a fuel cell electrolyte conditioning system/reservoir.

7. The emergency power system of claim 1, wherein said electrochemically regenerated air scrubber includes an air scrubber and a regenerative electrolytic cell.

8. The emergency power system of claim 1, wherein said air scrubber includes a reactor chamber, a fresh air inlet and a scrubbed air outlet.
